(19) United States
(12) Patent Application Publication
(10) Pub. No.: US 2026/0362087 A1
(43) Pub. Date: Nov. 12, 2026

(54) METHOD, DEVICE AND SYSTEM FOR DETERMINING A POSITION ASSOCIATED WITH A ROUTE OF A REMOTELY CONTROLLED VEHICLE

(71) Applicant: ORANGE, Issy-les-Moulineaux (FR)

(72) Inventor: Fanny PARZYSZ, CHATILLON (FR)

(21) Appl. No.: 19/129,502

(22) PCT Filed: Nov. 10, 2023
(86) PCT No.: PCT/EP2023/081388

§ 371 Date: May 13, 2025

(30) Foreign Application Priority Data
Nov. 17, 2022 (FR) 2211981

(51) Int. Cl. H04W 4/02; G05D 1/226; G05D 1/249; G05D 109/20; G05D 111/30; H04W 4/44

(52) U.S. Cl. CPC H04W 4/025; G05D 1/226; G05D 1/249; H04W 4/44; G05D 2109/20; G05D 2111/32

(57) ABSTRACT

A method for determining a position associated with a route of a vehicle remotely controlled via a first communication network. The remotely controlled vehicle is configured to transmit a datum of a connectivity service to a remote entity via a second communication network. The method is implemented in a managing device capable of correlating the position with a connectivity service of the second communication network. The method includes: obtaining a piece of information on a location of the remotely controlled vehicle on the route and a characteristic relating to the connectivity service of the second communication network; and determining the position of the remotely controlled vehicle depending on the obtained piece of information on the location, the position further being suitable for setting up the connectivity service between the remotely controlled vehicle and the second communication network in accordance with the obtained characteristic.

### 1. CROSS REFERENCE TO RELATED APPLICATIONS

This Application is a Section 371 National Stage Application of International Application No. PCT/EP2023/081388, filed Nov. 10, 2023, and published as WO 2024/104892 A1 on May 23, 2024, not in English, which claims priority to and the benefit of French Patent Application No. FR2211981, filed Nov. 17, 2022, the contents of which are incorporated herein by reference in their entireties.

### 2. TECHNICAL FIELD

The present disclosure relates to the general field of telecommunications, and more particularly to the field of moving vehicles attached to a communication network. In particular, the present disclosure relates to a method for determining a position that is both close to a location of a vehicle and that will further allow the vehicle to be attachable to an entity of a communication network so as to ensure the availability of a connectivity service meeting its needs in respect of connectivity to this communication network. The present disclosure is applicable, in a particularly advantageous but completely non-limiting manner, to enablement of suitable transfer, dynamically, of data between a drone, or an entity within the drone, and a communications network, when the drone is moving over a route.

### 3. PRIOR ART

In the prior art, remotely controlled vehicles, such as robots, autonomous automobiles or drones, are undeniably an asset in the implementation of many services or applications, also identified as verticals when deployment is planned in a 5G network (5G standing for 5th Generation). Support for firefighters and emergency services, inspection of high-voltage lines, medical delivery solutions, surveillance of industrial sites, and provision of security for public events are some of the services that could benefit from the deployment of such remotely controlled vehicles. However, when it is a question of drones, only VLoS flights (VLoS standing for Visual Line of Sight) are currently allowed, i.e. flights with a human pilot in direct proximity to the drone, this very greatly limiting development of the market. Being able to fly a drone remotely, i.e. to employ non-VLoS flight, while still monitoring the drone in real-time from a control center, is essential in many scenarios.

There are exemptions for BVLoS flights (BVLoS standing for Beyond VLoS), but these remain subject to lengthy and complex authorization/certification procedures and the availability of a service ensuring reliable connectivity of the drone is not currently one of the criteria taken into account for these flights. Estimation/prediction of connectivity along a path, with a view to monitoring and controlling the drone, is being studied by a number of consortia, such as the ACJA (which stands for Aerial Connectivity Joint Activity). However, the concept of drone connectivity remains incomplete because this connectivity, as taken into account by these consortia, does not meet every need. Specifically, in general, a drone has two streams of data to transmit or receive: a “command and control” stream, allowing the drone to be monitored and piloted remotely, and a stream of “payload” data, i.e. data delivered by entities (cameras, sensors, etc.) placed on board the drone with a view to carrying out a mission.

However, connectivity, as envisaged in the studies in progress, is a minimum radio connectivity, i.e. the connectivity required to meet civil aviation requirements regarding “command & control”. Typically, this command and control stream corresponds to a stream of 10 kbps, with a high network availability and a high level of resilience/redundancy. It should also be noted that these requirements are “standard”, in so far as they do not really depend on the mission: a fully automated delivery drone must benefit from the same level of monitoring as an inspection drone taking 360° video of a building. However, the requirements of the stream of “payload” data for such an inspection service are different, in particular in terms of bandwidth, to the requirements of the command and control stream, bearing in mind moreover that the communication networks used for the two streams, i.e. the control stream and the stream of payload data, may be distinct. Next-generation networks, in particular 5G networks, even though they are expected to be an adequate solution for the transfer of streams of “payload” data, are not necessarily available everywhere in a given territory, and do not necessarily make it possible to ensure data transmissibility anywhere and for every given mission or application of the drone, i.e. to guarantee an availability and/or quality of service expected for the stream of payload data, the characteristics of which may differ greatly from those of the control stream.

The present disclosure aims to provide improvements with respect to the prior art.

### 4. SUMMARY

The situation is improved by virtue of a method for determining a position associated with a route of a vehicle remotely controlled via a first communication network, the remotely controlled vehicle being configured to transmit a datum of a connectivity service to a remote entity via a second communication network, said method being implemented in a managing device capable of correlating the position with a connectivity service of the second communication network, the method comprising:
obtaining a piece of information on a location of the remotely controlled vehicle on the route,
obtaining a characteristic relating to the connectivity service of the second communication network,
determining a position of the remotely controlled vehicle on the route depending on the obtained piece of information on the location, said position further being suitable for setting up the connectivity service between the remotely controlled vehicle and the second communication network in accordance with the obtained characteristic.

The determining method is novel and inventive since it makes it possible to configure a movement of a remotely controlled vehicle, such as a drone for example, depending on a connectivity service allowing connectivity of the remotely controlled vehicle to a communication network. The movement of the vehicle may be controlled via a first communication network, for example of satellite or cellular type, and the connectivity service may be set up via a cellular network, possibly distinct from the first network, or Wi-Fi for example. More precisely, such a vehicle must be able to transmit or receive data from a second communications network, for example operated by a telecommunications service provider, during its movement. Bearing in mind that during this movement, the vehicle is not necessarily constantly capable of connecting to the second communication network or of benefiting from connectivity such as to allow transmission of data relating to any service, the method makes it possible to dynamically provide the vehicle with waypoints allowing it to effectively transmit and/or receive data from the second communication network in accordance with a required quality level.

Bearing in mind that the communication network allowing data of a communication service or connectivity service to be routed is not necessarily the network used to control the movement of the vehicle, or indeed that the data channel used to control the vehicle may be a channel that does not allow data to be transmitted to a remote entity via a communication network, the mere fact of being able to maintain control over the vehicle does not guarantee that data transmission in accordance with a characteristic of the connectivity service, irrespectively of whether it is a quality-of-service, bandwidth, security or some other type of characteristic, will be able to be set up at any time and in any place.

The obtained piece of location information may correspond to a position of a path or route of movement planned for the vehicle, and thus the method allows the movement of the vehicle to be configured depending on the determination of the position. The piece of location information may also be obtained during the actual movement of the vehicle, the determination of the position then making it possible to divert the path of the vehicle so that it approaches the determined position and benefits from a connectivity service providing the obtained characteristic. The method thus makes it possible to adapt the movement of a remotely controlled vehicle dynamically prior to its movement and/or during its movement and thus take into account the possible needs of the vehicle and/or of an application for which data must be transmitted between the vehicle and the communication network. The method is further applicable both to transmission of data from the vehicle to the second communication network and for transmission of data from second network to the remotely controlled vehicle.

The method thus makes it possible to adapt the movement of a remotely controlled vehicle depending on an architecture of a second communication network with which the vehicle communicates data and depending on a predicted position of the vehicle or on an actual position of a vehicle during its movement. The connectivity service may be an application or a set of applications having common characteristics. A given second network may offer different connectivity services, depending on the access network in question or the access point to which a vehicle is able to connect, and the method makes it possible to ensure that the vehicle will be positioned within range of, i.e. at a distance allowing it to attach to, an access entity of the second communication network allowing the characteristic of the connectivity service to be respected.

According to one aspect, in the determining method, a position on the route is determined prior to a movement of the vehicle over the route.

Advantageously, the method is implemented prior to the movement of the vehicle, thus making it possible to provide positions for connection to the second communication network and thus to determine a pathway of the vehicle depending on one or more determined positions. The vehicle may thus transmit and receive data predictively and thus save or collect data relating to the connectivity service in positions where the second communication network is able to guarantee the characteristic of the data to be transmitted.

According to another aspect, in the determining method, a position on the route is determined during movement of the vehicle over the route.

When the vehicle is moving, the predicted path of the vehicle may advantageously be modified so that the vehicle may, for example, empty data from a memory, the stored data being intended for the communication network, the determined position having in this case to correspond, for example, to a high bandwidth characteristic so that all the data may be transmitted in the shortest possible time, to reduce the transmission time and therefore the time of unavailability of the service for which the vehicle is moving. Thus, a vehicle may advantageously be diverted from its path in order to be able to attach to an equipment of the second communication network capable of satisfying the characteristic of the data to be transmitted. According to another example, the path is updated so that the vehicle updates its configuration and obtains, in a secure manner, and in accordance with the obtained characteristic, configuration data originating from the second communication network.

According to another aspect, in the determining method, said characteristic relating to the connectivity service is at least one characteristic selected from the following group:
a type of antenna of an access network of the second communication network,
a technology implemented in the second communication network,
a radio configuration of an access network of the second communication network,
a type of interface of communication of the vehicle with the second communication network,
a protocol of communication of the vehicle with the second communication network,
a specific architecture of the second communication network.

The characteristic relating to the datum to be transmitted may advantageously comprise one or more distinct characteristics among a type of antenna or a technology of the second communication network, for example indicating whether it is a 3G, 4G, 5G or Wi-Fi network, or indicating whether millimeter-wave access is possible, allowing a transfer of data at very high speed in a restricted region, the type of interface allowing the vehicle to communicate with an access equipment of the second communication network or indeed even to benefit from a specific network architecture, local breakout roaming for example, allowing the data to be routed to a particular server. This feature thus makes it possible to select an access network of the second communication network taking into account the position of the vehicle but also characteristics, in particular technological characteristics, of the second communication network and of the vehicle, in order to enable the transfer of data.

The characteristic relating to the connectivity service comprises, according to one example, configuration parameters of the second communication network or of an access equipment of the second communication network, such as parameters (use, availability, allocation) relating to RB resources (RB standing for Resource Block), the load of an interface (e.g. S1 interface) of a 4G or 5G or xG access equipment, available capacities, hardware load, and/or SON parameters (SON standing for Self-Organized Networks). The characteristic of the connectivity service may also correspond to a load-balancing parameter allowing, for example, data from the vehicle to be routed via two communication networks or two access equipments of a communication network, within radio range of the determined position. According to another example, the parameter of the connectivity service relates to a load of the communication network, for example in terms of the number of terminals or of vehicles connected to this communication network at a given time. Specifically, a network or access equipment of a communication network in principle configured to set up the connectivity service will potentially not be selected because of the number of vehicles already connected to this network, which could make it inoperative or incapable of meeting a quality of service required for the transport of data of the vehicle. For example, in a 4G or 5G network, a vehicle will not access the network via the nearest eNB or NR, respectively, but via an eNB or NR, respectively, that is further away because it is more suitable in terms of load or availability (NR standing for New Radio).

These connectivity-service characteristics, like the other attributes or parameters used to determine the position, may be obtained dynamically and used depending on the position of the vehicle as it moves. A dynamic vehicle position of this type may be used to determine successive positions for the vehicle during its movement, thus allowing it to benefit from a connectivity service meeting its data-transmission needs during its movement, including on route modification, and taking into account the management of the resources available on the network at the time in question, in accordance with the movement of the vehicle.

According to another aspect, the determining method further comprises obtaining at least one attribute relating to the datum to be transmitted, a position of the remotely controlled vehicle on the route further being determined depending on the at least one obtained attribute.

Advantageously, the managing device implementing the determining method obtains one or more attributes relating to the data relating to the connectivity service to be transmitted between the vehicle and the second communication network. This attribute may correspond irrespectively and non-exhaustively to a volume of data to be transmitted, to a time for transmitting the data, to a minimum bandwidth required for transmitting the data, to a maximum latency required for transmitting the data, to a data processing capacity of the second communication network or even to a characteristic relating to an uplink or downlink for the data to be transmitted over the second network.

These various pieces of information may thus advantageously be used to determine a position where the vehicle will be able to effectively transmit data to the second communication network in accordance with these requirements. These attributes may further be used to select one of a plurality of positions determined based on the characteristic of the second communication network and on the location of the vehicle. The attribute relating to the datum to be transmitted may also be a time of movement of the vehicle, possibly supplemented by a speed of movement of the vehicle.

According to another aspect, the determining method further comprises obtaining at least one characteristic associated with the vehicle, a position of the remotely controlled vehicle on the route further being determined depending on the obtained at least one characteristic associated with the vehicle.

Advantageously, the managing device obtains one or more characteristics of the vehicle in order to then determines the position most suitable for these characteristics. Among the obtained characteristics, the managing device receives pieces of technical vehicle information (interface, technology, protocol, radio configuration, etc.), this dynamic obtainment allowing a position to be selected in light of recent and up-to-date pieces of information, for example on the active connectivity interfaces of the vehicle. Among the other characteristics, the managing device may obtain a characteristic on the battery and optionally the level of charge of the battery and/or on the capacities of the vehicle in terms of speed of movement in particular. The obtained characteristic may also relate to a memory space of the vehicle, in particular in order to qualify the need to transmit data when the available memory space is small and this state may impact the collection of new data in particular.

According to another aspect, the determining method further comprises obtaining at least one attribute relating to the route, a position of the remotely controlled vehicle on the route further being determined depending on the at least one obtained attribute.

Advantageously, the managing device further obtains an attribute relating to the route, such as an altitude of the vehicle, a speed of movement, a heading to be followed by the vehicle as well as, for example, a time and date of movement, the latter piece of information in particular being useful when the position is determined prior to a movement of the vehicle over the route. The attribute may relate to the object or mission for which the vehicle is moving, and this attribute may in particular be used by the device to take account of a confidentiality or security criterion.

According to another aspect, the determining method further comprises obtaining at least one characteristic relating to the environment through which the vehicle is moving, a position of the remotely controlled vehicle on the route further being determined depending on the at least one obtained characteristic.

Certain geographical regions of an environment may be prohibited for the vehicle or these regions may be subject to permits or indeed certain frequencies may be prohibited in certain regions. These regions may further change over time and it is advantageous for the managing device to obtain these characteristics dynamically in order to take account thereof when determining the position. A position that is in principle advantageous with respect to the location of the vehicle, and to the capacities of the communication network in respect of rapid transfer of data in this position, may be discarded because the frequency used by the vehicle is prohibited there, and a better position will then have to be sought.

According to another aspect, in the determining method, determining a position of the remotely controlled vehicle on the route further comprises obtaining a piece of information relating to a length of time for which the device will be present at this position.

Advantageously, the managing device may enrich the method for determining the position with an indication of a length of time, whether it be a question of a period of time, of a time required for transmission of the datum or of a time or date at which presence of the vehicle at the determined position is scheduled, in order for example to avoid congestion in the communication network at the access point local to the position if too many vehicles could otherwise be located at the determined place at the same time and consecutively overload the second communication network.

According to another aspect, the determining method further comprises configuring an entity of the second communication network and/or of the vehicle, associated with a determined position, prior to transmitting data between the vehicle and the second communication network.

Advantageously, the determining method further comprises a step of configuring an entity of the second communication network and/or of the vehicle. For example, it may be necessary to configure a SIM or e-SIM card of the vehicle in connection with the second communication network associated with the position or indeed a slot of the second communication network, the characteristics of which are suitable for the data to be transferred, or even an MEC service (MEC standing for Mobile Edge Computing) to allow more efficient transmission of data from or to the vehicle. The configuration may consist in adding payload data or indeed in modifying the configuration of equipments of the second communication network or indeed in initiating charging in relation to the data to be transmitted.

The various aspects of the determining method that have just been described may be implemented independently of one another or in combination with one another.

The present disclosure also relates to a device for determining a position associated with a route of a vehicle remotely controlled via a first communication network, the remotely controlled vehicle being configured to transmit a datum of a connectivity service to a remote entity via a second communication network, said determining device being capable of correlating the position with a connectivity service of the second communication network and comprising:
an obtaining module, configured to obtain a piece of information on the location of the remotely controlled vehicle on the route and a characteristic relating to the connectivity service of the second communication network,
a determining module configured to determine a position of the remotely controlled vehicle on the route depending on the obtained piece of location information, said position further being suitable for setting up the connectivity service between the remotely controlled vehicle and the second communication network in accordance with the obtained characteristic.

This device is able, in all of its embodiments, to implement the determining method that has just been described.

The present disclosure also relates to a remotely controlled vehicle comprising a determining device, according to any of the embodiments described above.

The present disclosure also relates to a system for determining a position associated with a route of a vehicle remotely controlled via a first communication network, comprising
a determining device according to any of the embodiments described above,
a remotely controlled vehicle configured to transmit a datum of a connectivity service to a remote entity via a second communication network.

The present disclosure also relates to a computer program comprising instructions for implementing the steps of the determining method that has just been described when this program is executed by a processor and to a recording medium able to be read by a determination device and on which the computer program is recorded.

The aforementioned program may use any programming language and take the form of source code, object code, or intermediate code between source code and object code, such as code in a partially compiled form, or in any other desirable form.

The aforementioned data medium may be any entity or device capable of storing the program. For example, a medium may include a storage means, such as a ROM, for example a CD-ROM or a microelectronic circuit ROM, or else a magnetic recording means.

Such a storage means may be for example a hard disk, a flash memory, etc.

Moreover, an information medium may be a transmissible medium such as an electrical or optical signal, which may be routed via an electrical or optical cable, by radio or by other means. A program according to the disclosure may in particular be downloaded from a network such as the Internet.

Alternatively, an information medium may be an integrated circuit in which a program is incorporated, the circuit being designed to execute or to be used in the execution of the method in question.

### 5. BRIEF DESCRIPTION OF THE DRAWINGS

Other features and advantages of the disclosure will become more clearly apparent on reading the following description of particular embodiments, which are given by way of mere illustrative and non-limiting examples, and the appended drawings, in which:

FIG. 1 illustrates an environment in which the determining method is implemented according to one aspect of the disclosure.

FIG. 2 illustrates an environment in which the determining method is implemented according to another aspect of the disclosure.

FIG. 3 illustrates a communication infrastructure in which the determining method is implemented according to a first embodiment of the disclosure.

FIG. 4 illustrates a communication infrastructure in which the determining method is implemented according to a second embodiment of the disclosure.

FIG. 5 illustrates a communication infrastructure in which the determining method is implemented according to a third embodiment of the disclosure.

FIG. 6 illustrates the steps of a determining method according to one embodiment of the disclosure.

FIG. 7 illustrates the steps of a determining method according to another embodiment of the disclosure.

FIG. 8 illustrates a determining device according to one embodiment of the disclosure.

### 6. DESCRIPTION OF THE EMBODIMENTS

In the remainder of the description, embodiments of the disclosure are described in the context of a communication architecture comprising one or more communication interfaces. These networks may be implemented in order to route communication data to fixed or mobile terminals, and the networks may be implemented using physical equipments and/or virtualized functions. These networks may be used to route and/or process data of residential or business customers.

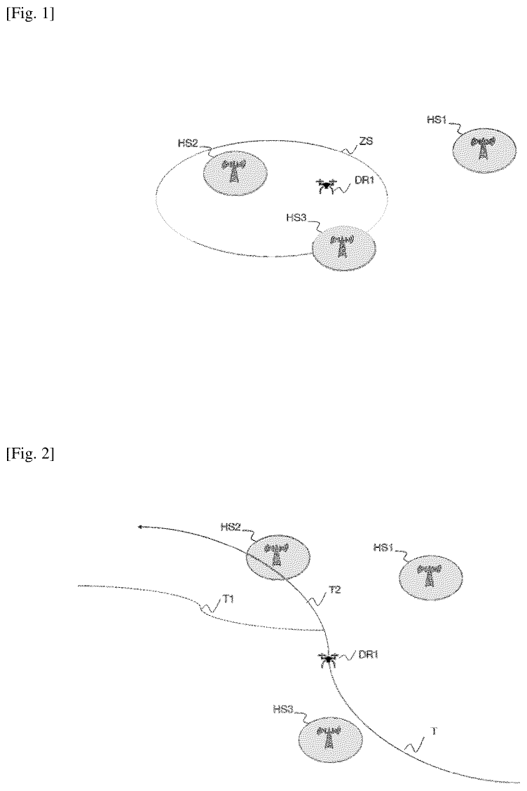

Reference will first be made to FIG. 1, which shows an environment in which the determining method is implemented according to one aspect of the disclosure. A remotely controlled vehicle DR1, which may be a drone or any vehicle moving under the control of a remote entity, is capable of moving, or authorized to move, in a region of movement ZS, which is a region of flight in the case of a drone. The vehicle DR1 is authorized to move to any point in the region bounded by the curve ZS. This curve ZS may be a set of points defined by geographical or topological coordinates. According to one aspect of the disclosure, the remotely controlled vehicle DR1 has available to it a set of functionalities for the phase of preparing its movement, and potentially its mission. Typically, this is the phase during which a controller, also called the remote controller in the embodiments described below, plans the path or region of movement, the time and date of the movement and obtains permits from aviation authorities in the case of a flying machine. The controller is either the (usually human) remote controller, the drone operator (usually a company) or, in the case of autopiloting, the platform for monitoring and controlling the vehicle, or the natural person legally responsible for the mission of the vehicle or any other accredited entity.

At this stage of the mission, the vehicle is in principle not yet attached to a communication network used in particular to control the vehicle remotely or to transfer data related to its mission. The vehicle obtains, before its actual movement in accordance with the plan made by the controller, hotspots HS1, HS2, HS3 allowing it to attach to a communication network, which may be identical to or distinct from the communication network used to control the movement of the vehicle, in accordance with a characteristic of a connectivity service. These hotspots may provide various types of connectivity (Wi-Fi, cellular of 2G, 3G, . . . , 5G or xG type). In the case where, for example, the communication network used to control the vehicle during its movement is the same as the communication network comprising one or more of the hotspots HS1, HS2, HS3, then these hotspots HS1, HS2, HS3 may correspond to regions where the vehicle is able to benefit from a bandwidth higher than a certain threshold (for example, a bandwidth higher than average) and/or is able to benefit from connectivity guaranteeing a low latency for example or indeed even a specific quality of service for a connectivity service. According to another example, the communication network used to control the vehicle is distinct from the communication network comprising the hotspots HS1, HS2 and HS3.

According to this embodiment, the remotely controlled vehicle is informed of the hotspots and of the associated positions before its actual displacement and its movement may be configured in light of knowledge of these hotspots. These hotspots HS1, HS2, HS3 are further determined depending on the locations of the vehicle during its movement, for example so that the vehicle may reach the nearest hotspot HS1, HS2 or HS3 provided that the latter verifies the characteristic of the connectivity service. The vehicle may thus be informed of a plurality of hotspots, these hotspots having specific characteristics relating to the connectivity of the vehicle. In the case where the communication network (or first network) used to control the movement of the vehicle is distinct from the communication network (or second network) used to transmit payload data relating to the service or mission of the vehicle, these communication networks may be distinct in that they have the following architectures:
the first communication network and the second communication network use distinct transmission technologies (satellite, Wi-Fi, cellular, etc.);
the first communication network and the second communication network may use distinct frequency bands (for example, frequencies below 6 GHz or above 6 GHZ, including millimeter waves) or distinct cells in the same technology, the same cellular technology for example;
the first communication network and the second communication network are implemented via distinct network slices, possibly on the same physical communication network;
the first communication network and the second communication network are implemented by different network operators.

Reference will now be made to FIG. 2, which shows an environment in which the determining method is implemented according to another aspect of the disclosure. In FIG. 2, the same entities are found as in FIG. 1, namely the remotely controlled vehicle DR1, and the hotspots HS1, HS2 and HS3. In this embodiment, the vehicle DR1 is already moving and attached to a communication network so that the vehicle may be remotely controlled during its movement. This embodiment requires the vehicle to be constantly attached to this communication network used to control it, so that the vehicle may remain constantly under control during its movement. According to one example, the communication network is a cellular network, typically a 5th generation (5G) network. The vehicle is thus scheduled to move along a path T then T1. Thus, according to one example, the vehicle obtains, before its movement, a path T, T1 that it will have to follow during its movement. The vehicle further obtains, dynamically, pieces of information relating to hotspots HS1, HS2 and HS3 corresponding, for example, to hotspots where it will be able to benefit from a higher bandwidth. These hotspots will have been determined beforehand based on a location of the vehicle and a characteristic relating to the connectivity service. Thus, a vehicle intended to move over a path T, T1 will be able to be diverted to a path T, T2 so that the vehicle may benefit from a better connectivity or even a higher bandwidth in the hotspot HS2, which would not have been possible if it had followed its intended path, namely T, T1. The characteristic relating to the connectivity service may be sent by the vehicle DR1 to a device responsible for determining a position, corresponding to the hotspot HS2, or indeed by an entity responsible for example for managing the mission for which the vehicle is moving.

It should be noted that the two embodiments of FIG. 1 and FIG. 2 are not exclusive and may be implemented in a complementary manner in another embodiment. Thus, the functionalities implemented upstream of the movement of FIG. 1 may be applied before the start of the mission or of the movement of the vehicle, and then the functionalities implemented during movement, as shown in FIG. 2, may be applied, in particular to refine or correct what was planned before movement, or to overcome an unexpected situation, in particular when the path of the vehicle is modified following an unforeseen circumstance or when the vehicle has a specific unforeseen need, typically if it needs to update software or must quickly transmit data to a remote entity. In the embodiment of FIG. 2, a single communication network or two communication networks may be used as in FIG. 1.

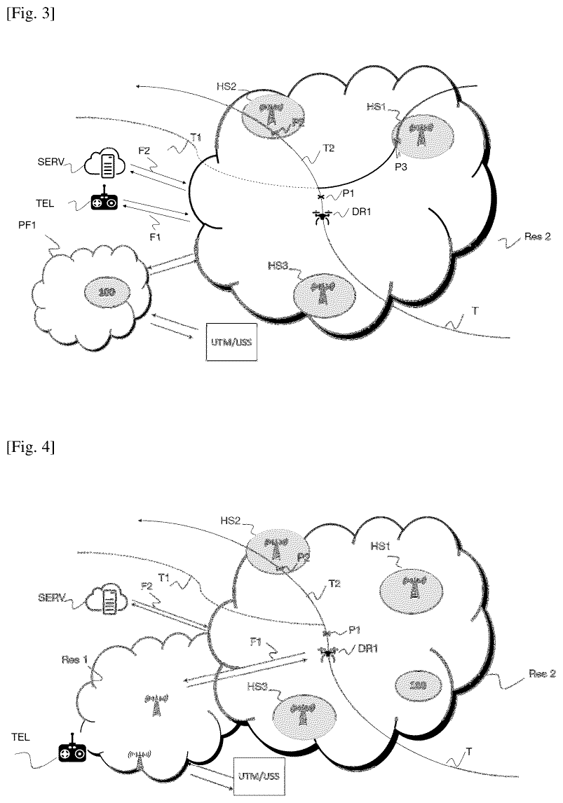

Reference will now be made to FIG. 3, which illustrates a communication infrastructure in which the determining method is implemented according to a first embodiment of the disclosure. In this embodiment, a single communication network Res 2 is employed.

In FIG. 3, non-limitingly, the remotely controlled vehicle DR1 is a drone.

A UTM/USS entity (UTM standing for Unmanned Aircraft Systems (UAS) Traffic Management and USS standing for UAS Service Suppliers) in particular provides services allowing aviation management, drone identification, drone flight planning and clearance of drone missions by aviation authorities. In order to carry out these missions, it interacts with a mediation platform PF1. The mediation platform PF1 allows drone managers and customers to interface with operators in charge of communication networks such as the operator in charge of the communication network Res 2. This platform makes it possible to match needs in terms of value-added services, i.e. needs related to the drone mission, and services permitting connectivity of the drone to the communication network Res 2. This mediation platform PF1, which corresponds to a management entity, comprises a determining device 100 configured to correlate the position of a drone with a connectivity service of the communication network Res 2. The mediation platform PF1 and the determining device 100 also interact with the communication network Res 2, in order to be able to ensure this correlation. The communication network Res 2 in particular comprises the three hotspots HS1, HS2, HS3 corresponding to a high-bandwidth characteristic, for example a bandwidth greater than 100 Mbit/s. In one example, the hotspots HS1, HS2, HS3 are Wi-Fi hotspots. The drone DR1 moves on a path T, T1 determined by the UTM/USS entity prior to the flight of the drone DR1, in particular depending on the mission for which the drone DR1 is required to move. The mission may be a remote monitoring mission, an inspection mission during which an industrial site is to be inspected or any other mission requiring an exchange of “payload” data with a data server SERV via data streams F2. The drone DR1 is remotely controlled by a remote controller TEL allowing the movement of the drone DR1 to be controlled remotely via data streams F1.

In this example, the communication network used to control the movement of the drone DR1 and the network used to allow the exchange of application data relating to the mission of the drone DR1 with the server SERV are the same, namely the communication network Res 2. The determining device is informed at regular intervals of the position of the drone DR1 during its movement, in particular in order to verify that the drone DR1 is moving in accordance with the initially decided path T, T1. The determining device 100 thus obtains the position P1. This position may be obtained from the drone DR1 or indeed by the UTM/USS entity or by the remote controller TEL or indeed by the network Res 2 (for example, by virtue of use of geolocation functions).

Furthermore, the determining device obtains, regularly or irregularly, one or more characteristics relating to the connectivity service of the drone DR1. This characteristic may be obtained from a management entity of the hotspots HS1, HS2, HS3 or from a management entity of the communication network Res 2. The characteristic may comprise one or more of the following characteristics: a type of antenna of an access network of the hotspot HS2 of the communication network Res 2, a technology implemented in the communication network Res 2, a radio configuration of an access network or a specific network architecture (local breakout roaming for example) of the hotspot HS2 of the communication network Res 2, a type of interface of communication of the drone DR1 with the communication network Res 2, and more precisely of the hotspot HS2, a protocol of communication of the drone DR1 with the communication network Res 2 and specifically with an entity of the hotspot HS2.

According to one example, the determining device 100 also obtains one or more characteristics corresponding to the hotspots HS1 and HS3. On the basis of the location data and of the obtained characteristic of the connectivity service, the determining device 100 for example decides to divert the drone from the obtained location P1 to the position P2 defined depending on the position P1, which position is for example located at a distance smaller by a maximum value from P1 and contained within the hotspot HS2. This position P2 allows the drone DR1 to connect to the communication network Res 2 via the hotspot HS2, which is closer than the hotspots HS1 and HS3 and which is able to provide a connectivity characteristic such as obtained by the determining device 100. This new position P2, which was not present on the initially determined path T, T1, requires the path to be modified, the path then becoming T, T2. This new path comprises the determined position P2 of the drone FR1.

According to one alternative, the determining device 100 further obtains an attribute relating to the data to be transmitted using the connectivity service. According to one example, this attribute corresponds to a bandwidth required to route the datum, to a maximum latency for transmission of the datum, to a security level associated with the datum, or to a volume of data to be transmitted. This attribute may be transmitted by the drone DR1 or indeed by the UTM/USS entity or by the remote controller TEL or indeed by the data server SERV. The determining device 100 uses this attribute, or these attributes if there are more than one, to determine a position of the drone DR1 to be suggested for a path update. Thus, according to this alternative, the determining device 100 determines the position P3, which is defined not only depending on the position P1, it corresponding for example to a distance less than a maximum distance from the position P1, but also because of its coverage by the hotspot HS1 supporting the required connectivity-service characteristic allowing the attribute relating to the data to be transmitted between the drone DR1 and the data server SERV to be achieved.

Reference will now be made to FIG. 4, which illustrates a communication infrastructure in which the determining method is implemented according to a second embodiment of the disclosure.

In FIG. 4, the designations of the various entities of FIG. 3 have been reused and have the same meanings. The embodiment of FIG. 4 in particular differs from the embodiment of FIG. 3 in the presence of two communication networks Res 2 and Res 1. The remote controller TEL pilots the drone DR1 using the data stream F1 routed via the communication network Res 1. This communication network Res 1 uses any radio communication technology, network and application allowing the movement of the drone DR1 to be controlled remotely. The determining device 100 is, in this embodiment, included in the communication network Res 2 routing the application data of the drone DR1, i.e. the data relating to the mission for which the drone DR1 is moving. It may be a question of data relating to a monitoring, delivery or information-dissemination service or any service involving communication from or to the drone DR1, respectively, or to the SERV data server.

In this embodiment, the determining device 100 receives from the drone DR1 or from the remote controller TEL or from the communication network Res 1, or from the UTM/USS entity and therefore possibly via the communication network Res 1, a piece of information on the location of the drone DR1, corresponding to the position P1, which may be geographical datum such as a GPS datum, or a piece of information on topographic location with respect to the communication network Res 2 or the communication network Res 1. The determining device further obtains, from a management entity of the communication network Res 2, a characteristic relating to the service allowing connectivity of the drone DR1 with the data server SERV, this characteristic possibly corresponding, for example, to one or more geographical regions allowing a drone to attach to the hotspot HS1 and/or to the hotspot HS2 and/or to the hotspot HS3, these hotspots being able to offer connectivity to the communication network Res 2, the movement of the drone DR1 being controlled via the communication network Res 1 used for the movement and control of the drone DR1. Once the determining device has determined a position P2 based on the piece of location information P1 and on the characteristic HS2 relating to the connectivity service, if this position is different from the piece of location information, the determining device 100 may transmit this position P2 to the remote controller and possibly to the UTM/USS entity in order to have the drone DR1 moved to this position P2. The remote controller TEL then pilots the drone DR1 to the position P2 via the communication network Res 1, so that the drone DR1 may attach to the hotspot of the network Res 2 and benefit from a connectivity service corresponding to the required connectivity-service characteristic.

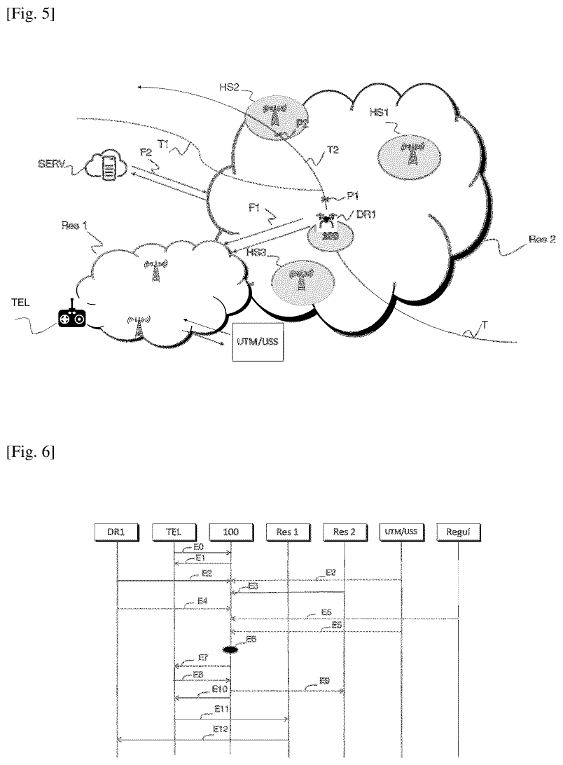

Reference will now be made to FIG. 5, which illustrates a communication infrastructure in which the determining method is implemented according to a third embodiment of the disclosure.

This third embodiment differs from the second embodiment shown in FIG. 4 in the implementation of the determining device 100 in the drone DR1. This embodiment allows the piece of location information to be obtained directly by the drone DR1, for example using a map or GPS interface. This embodiment further allows the drone to correlate the characteristic relating to the connectivity service with its own characteristics to determine a position. In particular, if the characteristic relates to a protocol and/or to a communication interface, the determining device 100 of the drone DR1 may determine a position depending on its location, on the obtained characteristic and on its own characteristics.

This example is also possible in the two embodiments of FIG. 3 and FIG. 4 provided that the determining device obtains, from the drone DR1 or from the UTM/USS entity, the characteristics of the drone DR1. The embodiment shown in FIG. 5 may also be implemented in the first embodiment where the first communication network Res 2 used for routing the payload data of the drone DR1 to and from the data server SERV and the second communication network Res 1 used to control the movement of the drone DR1 are identical and form a single communication network. According to one alternative, the two communication networks Res 2 and Res 1 are virtualized instances hosted in a single physical network.

Reference will now be made to FIG. 6, which illustrates the steps of a determining method according to one embodiment of the disclosure. In FIG. 6, the various entities and devices illustrated in the preceding figures feature again and have been designated by the same designations. FIG. 6 illustrates the steps implemented prior to the movement of the drone DR1.

In an optional step E0, the entity TEL for controlling the drone DR1 (or remote controller) transmits to a determining device 100 a request to activate the determining method. The reason why this request is sent is to ask for the method for determining a position associated with a route of a remotely controlled vehicle DR1, which non-limitingly is considered to be a drone in this example, to be activated. This request is optional because the method may be activated by default and, furthermore, a request may be valid for a set of drones. This step E0 may be carried out prior to movement of the drone DR1 or indeed when the drone DR1 is already moving. Optionally, on receipt of the activation request, a verification of subscription to the determining method may be carried out, in particular in the case of a service relating to the method that is chargeable. If such a subscription is not present by default, a subscription request may be submitted for validation, for example to the control entity TEL.

In a step E1, the determining device 100 responds to the control entity TEL that the determining method is indeed activated, possibly after having verified that the control entity TEL and the drone DR1 have indeed subscribed to the determining method.

In a step E2, the device 100 obtains a piece of information on the location of the drone DR1 or a set of pieces of location information, such as a path or a route planned for the drone DR1. This information may be transmitted by the drone DR1 or by the UTM/USS entity or even, according to one alternative not shown in FIG. 6, by the control entity TEL. This piece of location information may correspond to GPS datum or indeed to a cartographic datum making it possible to locate the drone DR1 in a spatial environment.

According to one example, the device 100 further obtains, in this step E2 or in a step distinct from step E2, from the drone DR1 or from the control entity TEL or from the UTM/USS entity, an attribute relating to the route followed by the drone DR1 during its mission. This attribute is in particular advantageous when the method is implemented prior to movement of the drone DR1. These attributes may in particular correspond, non-exhaustively, to an altitude of the drone DR1 during its movement, to a speed of movement of the drone DR1, to a heading followed by the drone DR1, and/or to a time and date of movement of the drone DR1. This attribute may be exploited by the determining device 100 to determine a position suitable for the altitude and for the movement of the drone DR1, for example through correlation of these pieces of information with pieces of information on the availability of equipments of the communication network Res 2 near the estimated location of the drone DR1 during its scheduled movement over a route.

According to another example, the determining device further obtains, in step E2 or in a step distinct from step E2, a characteristic associated with the drone DR1. This characteristic, transmitted by the drone DR1 or by the control entity TEL or by the UTM/USS entity corresponds, for example, to a type of interface (4G/5G, radio configuration, antenna type) and/or to a communication protocol supported and activated by the drone DR1 during its movement.

In the embodiment of FIG. 6, the network Res 1 is considered to be used for management of the movement of the drone DR1 and transmission of the control data of the drone DR1 by the control entity TEL. This network Res 1 must be able to ensure constant connection of the drone DR1 to its pilot, whether this pilot is human or automatic, remotely via the control entity TEL. The network Res 2 is used to route the payload data of the drone DR1, i.e. data relating to the mission of the drone DR1, this data possibly being audio data, video data or any other type of data of a service performed or fulfilled by the drone DR1. There is therefore no regulatory and/or safety obligation requiring the drone to have constant connectivity with the communication network Res 2, this being why it is advantageous to inform the drone DR1 of the positions in space where it may actually benefit from such a connectivity, so that it may, where appropriate, transmit data related to the value-added service. The determining method is also relevant when the networks Res 2 and Res 1 are the same, in particular to inform the drone DR1 about positions where it may benefit from a connectivity having a particular characteristic (high bandwidth, low latency, improved security, etc.).

In a step E3, the device 100 obtains, from the communication network Res 2, for example from an equipment for managing resources of the network Res 2, a characteristic relating to a connectivity service. According to one example, this step may occur after the determining device 100 has sent a piece of information on the movement of the drone DR1 or indeed it may be a question of sending characteristics for a given geographical region, associated with the movement of the drone DR1, this region being already known by the network Res 2. The characteristic for example comprises: a type of antenna of an access network of a geographic region of the communication network Res 2, a technology implemented in the communication network Res 2, a radio configuration of an access network or of a geographic region of the communication network Res 2, a type of interface of communication of the drone DR1 with the communication network Res 2 and more precisely of a geographic region, a protocol of communication of the drone DR1 with the communication network Res 2 and specifically with an entity of the network Res 2 in a geographic region. This characteristic may for example be transmitted to the device 100 in the form of a table indicating geographical regions associated with technologies and/or characteristics (bandwidth, latency, QoS, etc.) of the network Res 2 for these regions.

In an optional step E4, which may be conjoint with step E2 and precede step E3, the drone DR1 sends to the determining device 100 an attribute relating to the datum to be transmitted. This attribute for example relates to the value-added service provided by the drone DR1 and for which a connectivity to the network Res 2 is required. This attribute may relate to one or more attributes among: an average or maximum bandwidth required for the data to be transmitted or received, a latency to be guaranteed for the transmission of the data or more generally a quality of service associated with the data, a level of security and of confidentiality required for the data, a volume of data to be transmitted, a piece of information relating to a flight schedule or to a period of heavy load on the network Res 1 or any other attribute making it possible to determine a position allowing the drone DR1 to send and/or receive data via the network Res 2 in accordance with the obtained attribute. The device uses these attributes to determine the most appropriate position in particular with respect to the characteristics transmitted by the network Res 2 in step E3. If a plurality of value-added services are implemented by the drone DR1 during its movement, attributes associated with each service may be transmitted.

In an optional step E5, the device 100 obtains a characteristic relating to the environment through which the drone DR1 is moving. This characteristic, which is for example transmitted by a regulatory entity, responsible for example for control of the airspace in question and/or control of drone movements in the airspace, and/or a UTM/USS entity, may contain a piece of information on regions prohibited to the drone DR1 or on geographical regions within which it is prohibited to transmit data, or on regions within which certain radio transmission frequencies are prohibited. This characteristic is taken into account by the determining device 100, to determine a position having this environmental characteristic.

On the basis of the received pieces of information, some of which are optional, in steps E2 to E5, the determining device 100 determines a suitable position for the drone DR1, actually allowing it, from a location, to attach to an access equipment of the communication network Res 2 and to transmit and/or receive data associated with a value-added service, relating to the mission and movement of the drone DR1.

Since the method is implemented prior to the actual movement of the drone DR1, the latter may thus obtain a set of constituent positions of a path ensuring its connectivity to a communication network Res 2, which is possibly distinct from the network Res 1 used by the control entity TEL to guide the drone DR1, and in accordance with the characteristics and attributes received from the various entities in steps E2 to E5. According to one alternative, the device 100 determines more than one position for the drone DR1. For example, from a given location, the device 100 may determine a plurality of positions from which the drone DR1 or an entity responsible for the movement of the drone DR1 will have to select one.

Apart from the determined position, the device 100 may determine a length of time for which the drone DR1 will be present at this position. In particular in the case where the position corresponds to a hotspot, the device may determine the length of time for which the drone DR1 may attach to an access equipment of the network Res 2, for example taking into account the speed of movement of the drone and/or the energy resources of the drone DR1.

In an optional step E7, the device 100 transmits to the control entity TEL a position, or a set of determined positions in the case where a plurality of positions were determined from one location. In a step E8 which is also optional, the control entity TEL transmits the selected position to the determining device 100, it being possible for these steps E7 and E8 to be repeated for a set of successive positions, allowing the control entity TEL to define the path followed by the drone DR1 while having the guarantee that the drone DR1 will have a connectivity to the communication network Res 2. The determining device may further, in a step E9, transmit a piece of information on a configuration of an entity of the network Res 2, thus allowing the drone DR1 to actually attach to the network Res 2 when it reaches the determined position or beforehand, so that the drone is authorized to attach to the network Res 2. If the determining device 100 forms part of the network Res 2, this piece of information may be transmitted directly to the network Res 2, possibly via an entity for configuring equipments of the network Res 2. In the case where the device 100 is external to the network Res 2, this piece of configuration information will possibly be transmitted via a proxy equipment responsible for checking and verifying the configuration information. This piece of configuration information may comprise an update of QoS parameters associated with the data to be transmitted by the drone DR1 or to the drone DR1, as well as configurations of the equipments that will be involved in the transmission of the data. This configuration is particularly relevant in the case where the data to be transmitted relate to a specific service requiring suitable functions and/or configurations. It may comprise pre-configuration of the contract of subscription of the drone DR1, such as for example configuration of a SIM/eSIM, functions relating to instantiation of a network slice and/or of an MEC service (MEC standing for Mobile Edge Computing) on an access equipment of the network Res 2 to which the drone DR1 will attach when it reaches the determined position. For a 5G network slice, it is then a question, inter alia, of configuring the AMF entity (AMF standing for Access and Mobility Management Function) that acts as intermediary for management of QoS, the NSSF (standing for Network Slice Selection Function) the role of which is to select the network slice that will be used for transmission of data by the drone DR1, during its registration on the network, and the NRF (standing for Network Repository Function), i.e. the catalogue for control of the virtual functions of the network Res 2 and their instantiation in accordance with 3GPP procedures.

In the case of roaming, the determining device 100 may also communicate with network equipments of a visited network (not shown), which will interrogate those of the network Res 2, which is the home network, via procedures defined inter alia by the 3GPP.

In a step E10, the determining device transmits, to the control entity TEL, possibly via the UTM/USS entity, the one or more determined positions, so that it may configure the movement of the drone DR1 depending on these one or more positions.

In steps E11 and E12, the control entity TEL initiates the movement of the drone DR1 via the network Res 1, the movement being made in accordance with one or more positions determined by the determining device 100. According to one alternative, the control entity TEL transmits, to the determining device 100, a piece of information relating to passage of the drone DR1 to the determined position while the drone DR1 is actually passing to this position.

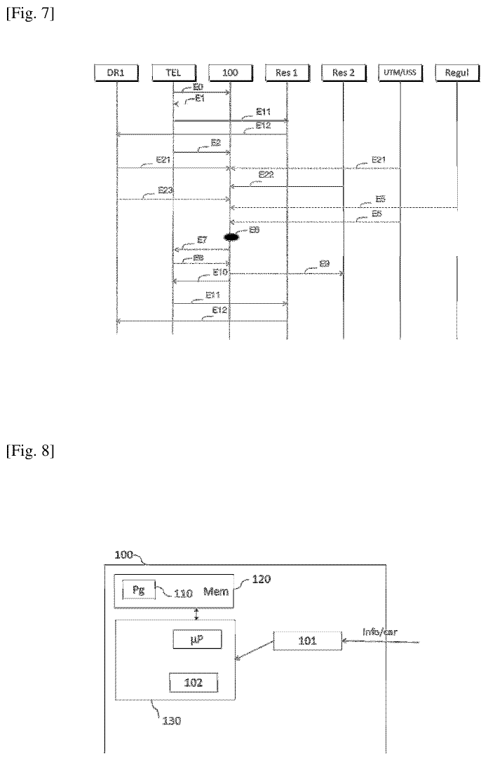

Reference will now be made to FIG. 7, which illustrates the steps of a determining method according to another embodiment of the disclosure. In FIG. 7, the various entities and devices illustrated in the preceding figures feature again and have been designated by the same designations. FIG. 7 describes the steps implemented during the movement of the drone DR1. These steps may be implemented consecutively or alternatively to the steps of FIG. 6. Specifically, the determining method may comprise a determining sub-method before the movement of the drone DR1 and a determining sub-method during the movement of the drone DR1 or indeed a single determining method before the movement of the drone DR1 or during the movement of the drone DR1.

FIG. 7 illustrates the case where a determining method has not been implemented before the movement of the drone DR1 and where the determining method is implemented during the movement. Steps E0 and E1, which are optional, are therefore present in FIG. 7, which would not necessarily be the case if the method were already activated before the movement of the drone DR1. In accordance with steps E11 and E12 described in FIG. 6, the drone DR1 is moving through an environment under the control of the control entity TEL via equipments of the communication network Res 1.

In a step E2, the control entity TEL transmits a piece of location information from the drone DR1 to the determining device 100. This piece of information indicates the current location of the drone DR1. This step E2 may be repeated at regular intervals or indeed the control entity TEL transmits a path of the drone DR1, possibly accompanied by information on the time of movement, thus providing in a preventive manner the successive locations of the drone DR1 during its movement. In the various cases, it is a question of a transmission of a piece of location information and this piece of information may be transmitted by the control entity TEL, as indicated in FIG. 7 or alternatively by the drone DR1 or the UTM/USS entity.

In a step E21, the drone DR1 sends to the determining device 100 a message indicating a need to send data with a high bandwidth, for example higher than 100 Mbit/s. This need may for example relate to a need to empty a memory card. According to one alternative, the message of step E21 is transmitted by the UTM/USS entity or the control entity TEL and corresponds, for example, to the need to change a data-processing algorithm embedded in the drone DR1, in order to configure it to reflect the progress of the mission. This need requires the drone to connect to the network Res 2 with a guarantee of sufficient bandwidth. According to another example, it is a question for the drone DR1 being able to attach to the network Res 2 while respecting a quality of service and/or security constraint requiring a specific connection to the network Res 2 or any other attribute relating to the datum to be transmitted.

In a step E22, the determining device obtains from the communication network Res 2, and more precisely for example from an administration entity of the network Res 2, a characteristic relating to the connectivity service, comprising for example the following information: spots around a gNB access entity connected to an AMF supporting a particular type of network slice, in the present case of broadband type, a spot with edge-computing capacity or a spot comprising an equipment that is lightly loaded. The characteristic of the connectivity service may further comprise a type of antenna of an access network of a geographic region of the communication network Res 2, a technology implemented in the communication network Res 2, a radio configuration of an access network of a geographic region of the communication network Res 2, a type of interface of communication of the drone DR1 with the communication network Res 2, and more precisely of a geographic region, a protocol of communication of the drone DR1 with the communication network Res 2 and specifically with an entity of a geographic region, a specific architecture of the network Res 2 (for example local breakout to a local server).

The connectivity characteristic, according to another example, corresponds to the load of an access entity (radio cell, gNB equipment) or to an average bandwidth value, for example equal to an average bandwidth value obtained for a set of client entities connected to the access entity for a determined length of time. This piece of information on load and/or average bandwidth may provide information on the average bandwidth and therefore the quality of service that the drone DR1 may obtain by connecting to the access entity.

This characteristic relating to the connectivity service may be transmitted to the determining device 100 prior to step E22 or indeed independently of reception by the determining device 100 of the message transmitted in step E22.

The determining device may advantageously further receive, in a step E23, which may be conjoint with step E22, a characteristic associated with the drone DR1 such as a maximum distance of movement, a state of the battery of the drone DR1, for example so as not to move the drone too far from the location taken into consideration received in step E2, on the amount of data to be transmitted or received, for example the number of files and their size, the speed of production of the data, a minimum bandwidth required, a maximum latency required, a specific compute capacity. These optional pieces of information, some of which may possibly be transmitted by the UTM/USS entity and/or the control entity TEL, may be taken into account by the determining device 100 to determine the most suitable position, in particular such that this position allows the drone DR1 to attach to the communication network Res 2 while guaranteeing that the constraints sent in the message E22 and the message E23 are met.

The determining device 100 may also receive messages in steps E5 from the UTM/USS and Régul entities, in accordance with the same steps of FIG. 6, and take into account the pieces of information transmitted in these messages when determining one or more positions of the drone DR1.

In step E6, the determining device 100 determines one or more positions of the drone DR1 taking into account the position or geographical location during movement of the drone DR1, the needs in terms of data transmission of the drone DR1 and the characteristics of the network Res 2 in a spatial radius compatible with the characteristics of the drone DR1 or, failing that, in a radius defined beforehand by the determining device 100, for example in consultation with the UTM/USS entity.

This determination may further comprise additional pieces of information on the one or more determined positions such as:
a datum relating to the geolocation of at least one access entity or a geographical region surrounding one or more access entities of the network Res 2. It may be a question of a three-dimensional geolocation, i.e. in addition with pieces of information relating to a flight height/altitude to be respected, in particular in the case of a restriction on the use of a frequency spectrum, possibly taking into account the pieces of information of the messages of step E5;
and/or a map of geographical regions in the region of flight and its surroundings, or along the path, or in the vicinity of the geographical location of the drone DR1.

Furthermore, other pieces of information may be determined by the determining device 100, namely:
information on a minimum time of presence required in the position or geographical region to transmit an amount of data. For example, if it is necessary to transmit 100 MB of data and the bandwidth available at the determined position is 10 MB/sec then the device may indicate that the drone DR1 must remain at least 10 seconds at the determined position or in the hotspot corresponding to the determined position, this potentially having an effect on the speed of movement to be stipulated for the drone DR1 in this determined position.

The device may further add a piece of information on the cost associated with transmitting the data at the determined position.

These pieces of information may further allow the control entity TEL to select one position among a plurality of positions determined by the determining entity 100.

In a step E7, the determining device 100 transmits to the control entity TEL, and/or possibly to the drone DR1 and/or to the UTM/USS entity, the various positions determined with respect to the location of the drone DR1 at a time t. The entity receiving these proposals, for example the control entity TEL, selects the position where the data will actually be able to be transmitted in accordance with the constraints and characteristics obtained in steps E21 to E5, from among the various determined positions.

The determining device 100 may supplement the information transmitted to the control entity TEL with the determined pieces of information indicated above (geolocation, map, time of presence). It may further transmit other characteristics, such as an optimized path to each position, this path possibly corresponding for example to a heading, a speed, a distance to travel and/or a set of waypoints to be respected, for example to avoid region where flight is prohibited or regions where the transmission of data is prohibited, located between the drone and the determined position or hotspot. The determining device may further indicate to implement gradual optimized transmission with the movement of the drone DR1, in particular when the latter cannot hover and park at the determined position. According to one alternative, in step E6, the determining device 100 determines and selects itself the best position or hotspot, for example the one closest to the obtained location or the one allowing optimal or fastest transmission, and communicates it to the drone DR1 with a view to an immediate change of path and movement to the selected position. The control entity TEL and/or the UTM/USS entity are then simply notified of this path modification in step E7 and the optional step E8 corresponds to an acknowledgement of reception of the message sent in step E7. The determining device 100 therefore momentarily assumes the role of control entity, moving the drone DR1 to the selected position via the network Res 1. In a step E9, which may be implemented before step E6 if the drone DR1 is redirected as a matter of urgency, the determining device 100 transmits a piece of information on a configuration of an entity of the network Res 2, thus allowing the drone DR1 to attach to the network Res 2 when it is present at the determined position. This piece of information is comparable to step E9 of FIG. 6. However, since it is a question of configuring one or more equipments of the network Res 2 so that the drone DR1 may obtain a connectivity and transmit or receive data relating to a value-added service, while the drone DR1 is in the process of moving, the configuration time may be lacking and this configuring step may be based on a minimal configuration, for example a default configuration allowing the drone DR1 to attach when it is present at the determined position.

In a step E10, the determining device transmits, to the control entity TEL, possibly via the UTM/USS entity, the one or more determined positions, so that it may configure the movement of the drone DR1 depending on these one or more positions.

In steps E11 and E12, the control entity TEL configures the movement of the drone DR1 via the network Res 1, the movement being configured in accordance with one or more successive positions determined by the determining device 100. After the one or more successive positions have been determined, the drone DR1 is possibly diverted from its initially planned path so as to be able to transmit data of an application service or of a configuration of the drone or of any application data of which are routed by the network Res 2. According to one alternative, the control entity TEL transmits, to the determining device 100, a piece of information relating to passage of the drone DR1 to the determined position while the drone DR1 is actually passing to this position.

Once the drone DR1 has left the determined position, the network Res 1 or the drone DR1 or the control entity TEL or the UTM/USS entity informs, according to one alternative, the determining device 100 of this departure in a step that has not been shown in FIG. 7. The device 100 may use this information to indicate to the drone DR1 or to the control entity TEL and possibly to the network Res 2 that the specific configuration required for transmission of data between the network Res 2 and the drone DR1 may be removed and that the configuration that was being employed before the drone DR1 arrived at the determined position may be reinstalled.

According to other embodiments, the two communication networks Res 2 and Res 1 are the same communication network Res and the steps of FIG. 6 and FIG. 7 are also valid for this embodiment.

In all the embodiments described above, the connectivity service for which a position is determined may be a service of a terminal included in the drone DR1. According to this example, the message exchanges of the drone DR1 may be implemented by the terminal in the drone DR1. This terminal may further be a data server communicating with a remote entity (terminal, server, equipment) via the communication network Res 2.

The drone DR1 may be replaced by any type of remotely controlled vehicle in the various embodiments and examples described above.

Reference will now be made to FIG. 8, which shows a determining device 100 according to one embodiment of the disclosure.

Such a determining device may be implemented in a mediation platform, this platform allowing the customers and managers of the drones to interface with the operators in charge of the communication networks. This determining device may be implemented in a management entity of a communication network, such as the second network, or indeed in the remotely controlled vehicle.

For example, the determining device 100 comprises a processing unit 130, equipped for example with a microprocessor μP and controlled by a computer program 110, stored in a memory 120 and implementing the determining method according to the various embodiments of the disclosure. On initialization, the code instructions of the computer program 110 are for example loaded into a RAM memory, before being executed by the processor of the processing unit 130. Such a determining device 100 comprises:
an obtaining module 101, configured to obtain a piece of information Info on the location of the remotely controlled vehicle on the route and a characteristic Car relating to the connectivity service of the second communication network,
a determining module 102 configured to determine a position of the remotely controlled vehicle depending on the obtained piece of location information, said position further being suitable for setting up the connectivity service between the remotely controlled vehicle and the second communication network in accordance with the obtained characteristic.

Although the present disclosure has been described with reference to one or more examples, workers skilled in the art will recognize that changes may be made in form and detail without departing from the scope of the disclosure and/or the appended claims.

1. A determining method comprising:
determining a position associated with a route of a vehicle remotely controlled via a first communication network, the remotely controlled vehicle being configured to transmit a datum of a connectivity service to a remote entity via a second communication network, said determining being implemented in a managing device capable of correlating the position with a connectivity service of the second communication network, the determining comprising:
obtaining a piece of information on a location of the remotely controlled vehicle on the route;
obtaining a characteristic relating to the connectivity service of the second communication network; and
determining the position of the remotely controlled vehicle on the route depending on the obtained piece of information on the location, said position further being suitable for setting up the connectivity service between the remotely controlled vehicle and the second communication network in accordance with the obtained characteristic.

2. The determining method as claimed in claim 1, wherein the position on the route is determined prior to a movement of the vehicle over the route.

3. The determining method as claimed in claim 1, wherein the position on the route is determined during movement of the vehicle over the route.

4. The determining method as claimed in claim 1, wherein the characteristic relating to the connectivity service is at least one characteristic selected from:
a type of antenna of an access network of the second communication network,
a technology implemented in the second communication network,
a radio configuration of an access network of the second communication network,
a type of interface of communication of the vehicle with the second communication network,
a protocol of communication of the vehicle with the second communication network,
a specific architecture of the second communication network.

5. The determining method as claimed in claim 1, further comprising obtaining at least one attribute relating to the datum to be transmitted, the position of the remotely controlled vehicle on the route further being determined depending on the at least one obtained attribute.

6. The determining method as claimed in claim 1, further comprising obtaining at least one characteristic associated with the vehicle, the position of the remotely controlled vehicle on the route further being determined depending on the obtained at least one characteristic associated with the vehicle.

7. The determining method as claimed in claim 1, further comprising obtaining at least one attribute relating to the route, the position of the remotely controlled vehicle on the route further being determined depending on the at least one obtained attribute.

8. The determining method as claimed in claim 1, further comprising obtaining a characteristic relating to an environment through which the vehicle is moving, the position of the remotely controlled vehicle on the route further being determined depending on the at least one obtained characteristic relating to the environment.

9. The determining method as claimed in claim 1, wherein determining a position of the remotely controlled vehicle on the route further comprises obtaining a piece of information relating to a length of time for which the device will be present at this position.

10. The determining method as claimed in claim 1, further comprising configuring an entity of the second communication network and/or of the vehicle, associated with the determined position, prior to transmitting data between the vehicle and the second communication network.

11. A device for determining a position associated with a route of a vehicle remotely controlled via a first communication network, the remotely controlled vehicle being configured to transmit a datum of a connectivity service to a remote entity via a second communication network, said determining device being capable of correlating the position with a connectivity service of the second communication network and comprising:
at least one processor; and
at least one non-transitory computer readable medium comprising instructions stored thereon which when executed by the at least one processor configure the device to:
obtain a piece of information on a location of the remotely controlled vehicle on the route and a characteristic relating to the connectivity service of the second communication network; and
determine a position of the remotely controlled vehicle on the route depending on the obtained piece of location information, said position further being suitable for setting up the connectivity service between the remotely controlled vehicle and the second communication network in accordance with the obtained characteristic.

12. A remotely controlled vehicle comprising the device as claimed in claim 11.

13. A system for determining the position associated with the route of the vehicle remotely controlled via the first communication network, the system comprising:
the device as claimed in claim 11,
the remotely controlled vehicle.

14. (canceled)

15. A non-transient computer-readable recording medium on which a program comprising instructions for implementing a determining method is recorded, the instructions, when executed by at least one processor of a managing device, configure the managing device to implement a method comprising:
determining a position associated with a route of a vehicle remotely controlled via a first communication network, the remotely controlled vehicle being configured to transmit a datum of a connectivity service to a remote entity via a second communication network, said managing device capable of correlating the position with a connectivity service of the second communication network, the determining comprising:
obtaining a piece of information on a location of the remotely controlled vehicle on the route;
obtaining a characteristic relating to the connectivity service of the second communication network; and
determining the position of the remotely controlled vehicle on the route depending on the obtained piece of information on the location, said position further being suitable for setting up the connectivity service between the remotely controlled vehicle and the second communication network in accordance with the obtained characteristic.
